(19) United States
(12) Patent Application Publication
(10) Pub. No.: US 2010/0245066 A1
(43) Pub. Date: Sep. 30, 2010

(54) Automotive Ultrasonic Sensor System with Independent Wire Harness

(76) Inventors: Guner R. Sarioglu, Oakland Twp, MI (US); Horst Daniel Diessner, Belleville (CA); Julien Tudor, Shelby Township, MI (US); Brian J. Winden, Waterford, MI (US); Ryan Xue, Windsor (CA)

Correspondence Address: MAGNA INTERNATIONAL, INC., 337 MAGNA DRIVE, AURORA, ON, L4G-7K1, CA

(21) Appl. No.: 12/727,491

(22) Filed: Mar. 19, 2010

Related U.S. Application Data
(63) Continuation-in-part of application No. PCT/CA08/01862, filed on Oct. 23, 2008.
(60) Provisional application No. 61/000,091, filed on Oct. 23, 2007.
(60) Provisional application No. 61/161,478, filed on Mar. 19, 2009.

(51) Int. Cl. B60Q 1/00

(52) U.S. Cl. 340/436

(57) ABSTRACT

A circuit arrangement having a master microcontroller operably connected to a sensor for detecting a parameter. A power communications line is connected between the power source, master microcontroller, and sensor, wherein the power communications line carries power to the sensor as well as communication signals between the sensor and the master microcontroller. An embodiment of an automotive ultrasonic sensor system for object detection is disclosed, where the master microcontroller is connected to a number of external ultrasonic sensors via the circuit arrangement. The circuit arrangement is also advantageous in enabling a separate wire harnesses to be configured for the external ultrasonic sensors that operates at logic power levels (e.g., 5V) rather than the vehicular accessory drive voltage (typically 12V) present in the vehicular wire harness that interfaces the master microcontroller with other controllers in the vehicle.

### CROSS-REFERENCE TO RELATED APPLICATIONS

This application is a continuation-in-part of PCT International Application No. PCT/CA2008/001862 filed 23 Oct. 2008, which claims the benefit of U.S. Provisional Patent Application No. 61/000,091 filed on Oct. 23, 2007. This application also claims the benefit of U.S. Provisional Patent Application No. 61/161,478, filed 19 Mar. 2009, the contents of which are incorporated herein in its entirety.

### FIELD OF THE INVENTION

The invention relates generally to the field of sensor control circuits, and more particularly to automotive ultrasonic-based object detection sensor systems.

### BACKGROUND OF THE INVENTION

Sensor circuits have been utilized in automotive applications for providing a measure of data for a given parameter that is being monitored. For example, sensors are used in engine components for the purpose of determining the position of various valves or actuators during normal operation. Additionally, sensors have also been incorporated to measure environmental factors such as temperature, light, and objects external to the vehicle. Most sensor circuitry utilizes at least three wires for communicating between the sensor, microcontroller, and power source. For example, two wires will be used for supplying power to the microcontroller and sensor unit. A third and/or possibly fourth wire is used for communicating with the sensor unit. Reducing the number of wires and connections is desirable from the stand point of saving manufacturing time, equipment, as well as reducing the possibility of equipment failure by virtue of the fact that a lesser number of wires are being used. Thus, it is desirable to develop sensor circuits that need fewer than 3 wires between the microcontroller and the sensor.

While it desirable to reduce the manufactured cost of any automotive sensor system by reducing the number of components to achieve the same function, such as by reducing wire count, there are impediments to doing so. For example, the need exists to continue to interface with other pre-existing devices, components or circuitry in the vehicle. The invention seeks to ameliorate such issues.

### SUMMARY OF THE INVENTION

One aspect of the invention is directed to a circuit arrangement having a master microcontroller operably connected to a sensor for detecting a parameter. The microcontroller is connected to the power source by a microcontroller power line. A power communications line is connected between the power source, the master microcontroller, and the sensor. The power communications line carries power to the sensor as well as digital communication signals between the master microcontroller and the sensor.

The digital values communicated between the master microcontroller and sensor are preferably delineated by selective arrangement of the on and off flow of power over the power communications line.

The circuit arrangement of claim 1, further comprising a diode (26) and a capacitor (24) operably connected between said power communications line and a power supply input of said sensor (16) for continued supply of power to said sensor when no power flows over said power communications line.

The circuit arrangement preferably includes a low impedance line connected between the power source and the power communications line, and a high impedance line connected between the power source and the power communications line, where the high impedance line has a greater resistivity than the low impedance line. An impedance switch is disposed in the low impedance line and is controlled by the master microcontroller to control the flow of power through the low impedance line.

The power communications line is preferably connected to a data input of the sensor and to a ground signal via a first switch controlled by an output of the master microcontroller, thereby enabling the master microcontroller to communicate data signals to the sensor. Likewise, the power communications line is also preferably connected to an input of the master microcontroller and the ground signal via a second switch controlled by an output of the sensor, thereby enabling the sensor to communicate data signals to the master microcontroller.

The master microcontroller preferably controls the impedance switch to disconnect the power supply from the low impedance line when a communications signal or a portion thereof is transmitted over the power communications line.

In preferred embodiments, a bit of the digital communications signal has a logic value of 0 or 1. When the communication signal value is 1, a pulse at the power source voltage level is transmitted across the power communications line for a first predetermined time period and when said communications signal value is 0, a pulse at the power source voltage level is transmitted through the power communications line for a second predetermined time period. Each bit is preferably transmitted within a predetermined time window greater than the first or second predetermined pulse periods.

The sensor is preferably configured for active traffic environment sensing using ultrasound.

According to another aspect of the invention, a traffic environment sensing arrangement is provided for a vehicle having one or more body panels. The arrangement includes: a power source; a master microcontroller; a microcontroller power line connected between the power source and the master microcontroller; a plurality of ultrasonic sensors mounted in the one or more body panels; a power communications line connected between the power source, the master microcontroller, and each of said plurality of ultrasonic sensors. Each ultrasonic sensor further includes: a communications port and a sensor power line operably connected to the power source, wherein the sensor power line branches off of the power communications line; a capacitor on the sensor power line; and a diode positioned between the capacitor and the sensor power line.

Another aspect of the invention relates to an ultrasonic object detection sensor system for automotive applications. The system includes a main sensor having, in one enclosure, a master microcontroller functionally connected to a DC/DC voltage regulator, a vehicular communication interface, an internal ultrasonic sensor disposed within the enclosure, and an external sensor interface. The DC/DC regulator has an input receiving a power signal from a vehicular wire harness at a first voltage level and has an output providing a power signal at a different, second voltage level. The DC/DC regulator output is connected to at least the external sensor interface. The system also includes a plurality of ultrasonic sensors that are each disposed external of the enclosure. A wire harness interconnects the external ultrasonic sensors with the main sensor via its external sensor interface, where the wire harness operates at the second voltage level and carries at least one instance of the output power signal. The master microcontroller controls the internal and external ultrasonic sensors to send and receive ultrasonic bursts in order to detect a potential object within the field of view of each ultrasonic sensor. The master microcontroller consolidates data from the internal and external ultrasonic sensors and communicates the existence of an object to another device within the vehicle via the vehicular communication interface.

The wire harness preferably includes at least one power communication wire for connecting the plurality of external ultrasonic sensors, each power communication wire being connected to the external sensor interface and carrying both power and digital communication signals at the second voltage level between the external ultrasonic sensor and the external sensor interface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing and other aspects of the invention will be more readily appreciated having reference to the drawings, wherein:

FIG. 1 is a schematic of the two wire sensor circuitry;

FIG. 2a is a graph showing voltage versus time when the logic signal value is 1;

FIG. 2b is a graph showing voltage versus time when the logic signal value is 0;

FIG. 3 is an example of a logical communications scheme for the circuit arrangement;

FIG. 4 is a perspective view of the sensor circuit as incorporated in a two wire ultrasonic sensor arrangement;

FIG. 5 depicts a perspective view of the vehicle having a plurality of ultrasonic sensors connected to the vehicle;

FIG. 6 is a state diagram showing the state of switches in the two wire sensor circuitry for implementing the communications scheme;

FIG. 7 is a system block diagram of an ultrasonic traffic environment sensor system according to the prior art;

FIG. 8 is a system block diagram of a preferred embodiment of an ultrasonic traffic environment sensor system according to the invention;

FIG. 9 is a functional block diagram of a master sensor employed in the system of FIGS. 8; and

FIG. 10 is a functional block diagram of a slave sensor employed in the system of FIG. 8.

### DETAILED DESCRIPTION OF PREFERRED EMBODIMENTS

The following description of the preferred embodiments is merely exemplary in nature and is in no way intended to limit the invention, its application, or uses.

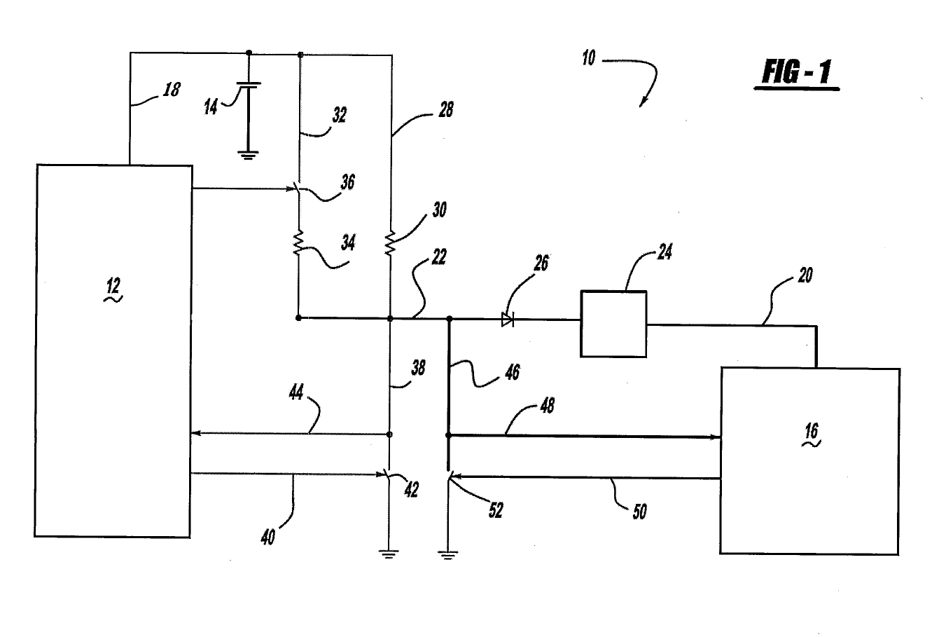

FIG. 1 is a schematic view of a circuit arrangement 10 having a master microcontroller 12, a power source 14, and a sensor 16. The circuit arrangement 10 in one embodiment of the invention is a two wire digital or active environmental sensor used to sense objects in the external vehicle environment. The sensor 16 can be, but is not limited to a traffic environment sensor, weather sensor and an object sensor. However, the scope of this invention is not limited to environmental sensors or digital technology. The sensor 16 is an ultrasonic type sensor that utilizes sonar or sound waves to detect the presence or absence of an object as well as the distance from the object. One particular embodiment of the invention shown in FIG. 5 depicts the sensor as being used as an active ultrasonic park assist sensor. However, it is within the scope of this invention for the sensor 16 to be any type of sensor for detecting a given parameter while being able to operate using the two wire technology. Both the sensor 16 and the microcontroller 12 are connected to the power source 14. The power source 14 in this particular circuit arrangement 10 has a power source level that is a 5 volt direct current power source such as a battery. The use of a 5 volt power source with this circuit arrangement 10 provides a significant advantage over other arrangements that typically use a 12 volt power source. Using a 5 volt power source allows the circuit arrangement to be connectable to the same power source as the vehicle electronic control unit which also uses a 5V power source. However, it is possible to have a different type of power source having a different voltage depending upon the particular needs of an application. For example any types of voltage power source can be used, however, it is contemplated that 6 volts and 12 volt power sources are within the scope of this invention.

The power source 14 is connected to the microcontroller 12 through a microcontroller power line 18. The sensor 16 receives power through a sensor power line 20 which is connected to a power communications line 22 that is connected to both the power source 14 and the microcontroller 12. The power communications line 22 transmits both power as well as bit line encoding that is both received by the sensor and sent to the microcontroller 12.

The sensor power line 20 has a capacitor 24 disposed on the sensor power line 20 and a diode 26 that separates the capacitor 24 and sensor power line 20 from the power communications line 22. The diode 26 allows power flow from the power source 14 to the capacitor 24, but does not allow power to flow in the direction from the capacitor 24 past the diode 26. The capacitor 24 is configured to supply power to sensor 16 during voltage drops. While this particular embodiment of the invention describes a capacitor 24 being used, it is possible for another suitable energy storage device to be used, such as a battery, switch capacitor or an inductor.

Connected between the power source 14 and the power communications line 22 is a high impedance line 28, which is an energy line having a high impedance resistor 30. A low impedance line 32 having a low impedance resistor is also connected to the power source 14. The low impedance resistor 34 has a resistivity that is lower than the high impedance resistor 30. The low impedance line 32 and high impedance line 28 run in parallel. However, the low impedance line 32 has an impedance switch 36 that is controlled by the master microcontroller 12. When the impedance switch 36 is closed, higher current passes through the power communications line 22 and onto the capacitor 24. When the impedance switch 36 is open, a lower current will pass through the power communications line 22. It is during this period of lower current in the power communications line 22 that the line can be used for carrying a communications signal between the master microcontroller 12 and the sensor 16.

The master microcontroller 12 has a microcontroller communications line 38 that is connected to the power communications line 22. The microcontroller communications line 38 is also connected to ground. A master microcontroller output 40 is connected to the microcontroller communications line 38 through a master microcontroller output switch 42. When the master microcontroller switch 42 is closed, signals are sent from the microcontroller 12 through the master microcontroller output 40 and onto the power communications line 22. The master microcontroller 12 also has connected to it a master microcontroller input 44 that is also connected to the microcontroller communications line 38 and receives signals from the sensor 16 via the power communications line 22.

The sensor 16 has a sensor communications line 46 that is connected to the power communications line 22 and ground. The sensor 16 has a slave sensor input 48 that selectively receives signals from the microcontroller 12 that are outputted through the master microcontroller output 40. The slave sensor input 48 introduces command signals to the sensor 16 that can cause the sensor to carry out a function such as sending and receiving ultrasonic sound waves. The sensor 16 in carrying out its functions will receive signals that are indicative of its function. For example, an ultrasonic sensor will receive signals that indicate the presence of an object in the path of the sensor 16. The signals received by the sensor 16 are transmitted to the microcontroller 12 through a slave sensor output 50. The slave sensor output 50 is controlled by a slave sensor switch 52 that will allow for signals to be transmitted from the slave sensor output 50 when the slave sensor switch 52 is in the closed position. When the slave sensor output switch 52 is in the closed position the sensor communications line 46 will go to ground.

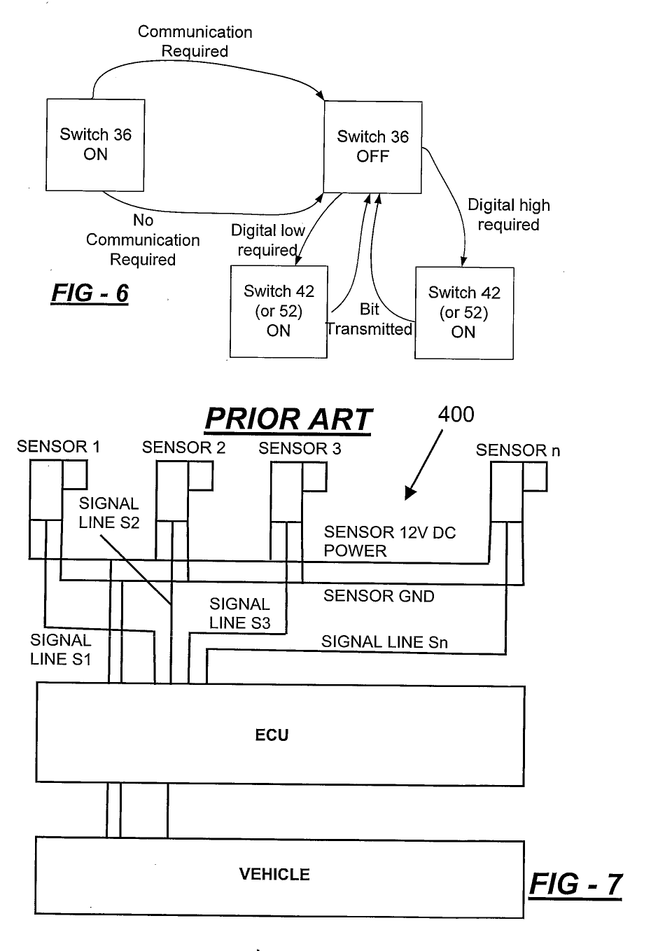

The operation of the circuit arrangement 10 is controlled by signals generated from the master microcontroller 12. During initial start up of the sensor 16 the master microcontroller 12 will cause the impedance switch 36 to be closed which allows more power to flow through the power communications line 22 to charge the capacitor 24. During periods that communications signals are transmitted to the sensor 16 the impedance switch 36 is open in order to impede the power supply and allow the power communications line 22 to carry a communications signal. The communications signals are generated between the master microcontroller 12 and the sensor 16 through the input and output ports connected to the microcontroller communications line 38 and the sensor communications lines 46. See FIG. 6, which provides a state diagram for the state of the impedance switch 36 and master microcontroller output switch 42 (or slave sensor switch 52) to transmit a digital low or high bit. However, the sensor 16 can encounter power fluctuation or voltage drops due to communication that can impair or disrupt sensor functions. The invention solves this problem by using the capacitor 24 to supply voltage during the period of power loss or fluctuation.

Communication can flow from the master microcontroller 12 to the sensor 16, and vice versa. In the former case, the master microcontroller grounds the power communications line 22, and in the latter case the sensor grounds the power communications line 22. In order to avoid collision, the system preferably employs a master/slave communications protocol where the master microcontroller 12 sends a command to the sensor 12 and the sensor sends a reply only in response to the command. After a communication session, the master microcontroller 12 can close the impedance switch 36 to recharge the capacitor 24, or, the impedance switch 36 can be closed at selected instances during a communication session to quickly recharge the capacitor in the event not enough power flows through the high impedance line.

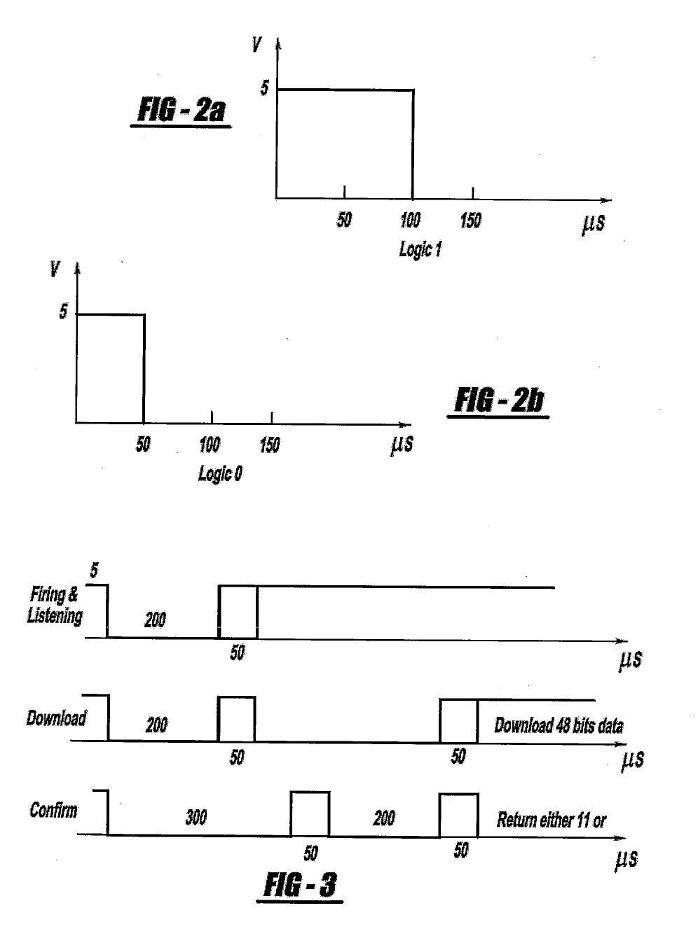

FIGS. 2a and 2b depict two graphs, which both exemplify the data line bit encoding for the circuit arrangement 10. FIG. 2a depicts the bit encoding when the logic value is set at 1 and FIG. 2b depicts the bit encoding when the logic value is set at 0. The data line bit encoding depicted in FIGS. 2a and 2b is distinct from other circuit arrangements for ultrasonic sensors because when the logic value is at 0, there is a pulse of 5 volts for 50 microseconds (in a 150 microsecond bit transmission window) instead of the voltage being 0. When the logic value is 1, there is a pulse of 5 volts for 100 microseconds (in a 150 microsecond bit transmission window). This permits the capacitor to be receiving a voltage charge even when the logic value is at 0 when compared to other system where the voltage value would be 0 when the logic value is 0. It also allows for communications data to be constantly transmitted through the power communications line 22, even when the logic value is 0.

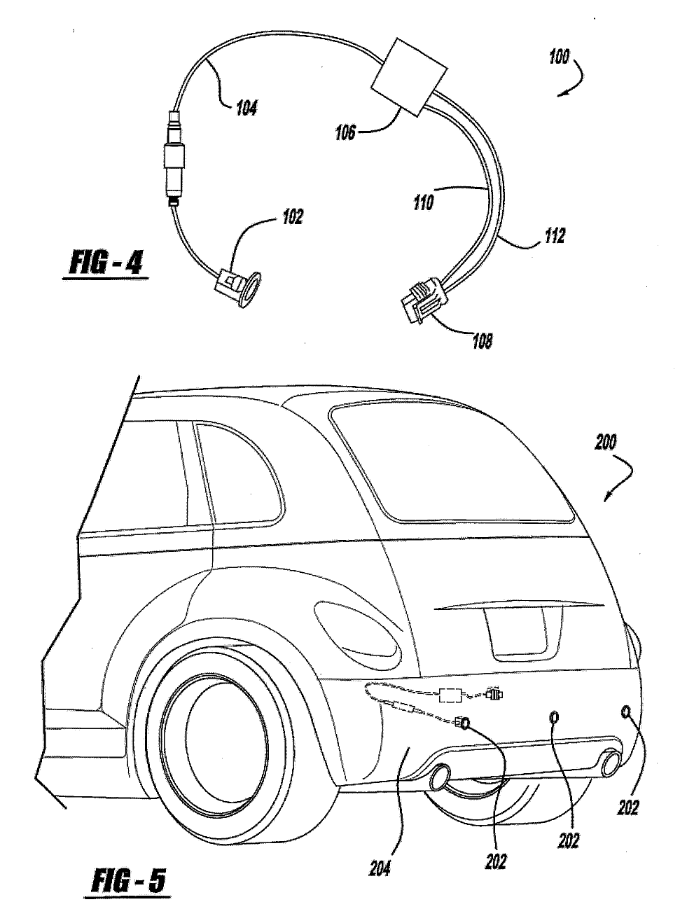

FIG. 3 depicts an example of a logical communications scheme signals between the microcontroller 12 and the sensor 16 during various phases of sensor operation.

FIG. 4 is a perspective view of the sensor circuit as incorporated in a two wire ultrasonic sensor arrangement 100. An ultrasonic sensor 102 has a power communications line 104 that extends to a circuit box 106 that contains the circuit arrangement 10 shown in FIG. 1. The power source connector 108 has two wires extending from the connector into the circuit box 106. One of the wires provides power to the master microcontroller and the other wire provides power to the circuit arrangement 10 that leads to the power communications line 104.

FIG. 5 depicts a vehicle 200 having a plurality of ultrasonic or traffic environment sensors 202 connected to a bumper 204 of the vehicle 200. In this embodiment, the plurality of ultrasonic sensors 202 are used as proximity sensors for alerting a driver of the vehicle 200 when objects are in the path of the vehicle 200 as the vehicle is backing up. The traffic environment sensors depicted on the vehicle 200 are used primarily for determining the presence or absence of an object in the path of the vehicle 200 while backing up. It is possible for the traffic environment sensors 202 to be used in other areas of the vehicle for providing proximity detection. For example, such sensors can be used for collision avoidance, parking assist, security, and other suitable uses where the detection of objects on the outside environment of the vehicle are desired.

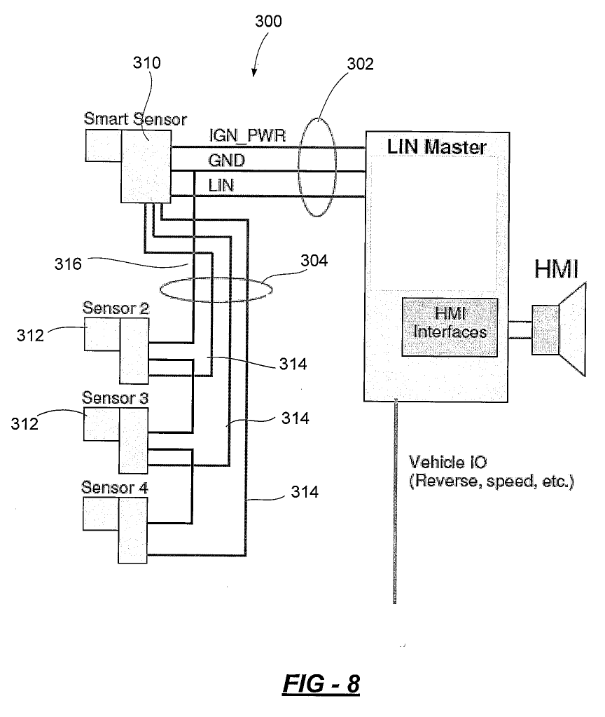

One particular implementation of an ultrasonic traffic environment sensing system 300 suitable for installation in the rear bumper of a vehicle is shown in system block diagram form in FIG. 8. Compared to conventional ultrasonic sensing systems, the system 300 minimizes the functional blocks and the wiring required to add such a system into a vehicle.

Consider first the topology of a current commercially available ultrasonic sensing system 400 as shown in FIG. 7. The conventional system 400 includes a number n of individual ultrasonic sensors 402, which are controlled by a central electronic control module (ECU) 404. The n ultrasonic sensors 402 each send and receive ultrasonic bursts in order to detect objects within the field-of-view of the sensor 402. Each ultrasonic sensor 402 pre-processes the analog data and converts the data into the digital domain. The communication interface to each sensor 402 is a digital interface consisting of low (0) and high (1) voltage signal states.

The ECU 404 communicates with and controls all the ultrasonic sensors 404. The ECU 404 processes of the collected raw data and provides the processed data to a vehicle controller 406 in order to drive a human-machine interface (HMI). The ECU 404 requires nine connections for a system 400 with four ultrasonic sensors 402. Each ultrasonic sensor must be provided with a common 12V DC power line (1 wire), sensor ground (1 wire), an individual communications signal line (4 wires). And the vehicle interface requires a 12V DC power line (1 wire), system ground (1 wire), and a system communications signal (1 wire).

Although not explicitly shown in FIG. 7, the conventional system 400 requires a DC/DC regulator in the ECU 404 as well as in every ultrasonic sensor 402. The DC/DC regulator in each ultrasonic sensor 402 may be integrated into an application specific integrated circuit (ASIC) but it is still present.

It would be desirable to design an ultrasonic sensor which utilizes only logic level signals (typically 5V) as this would allow the removal of the DC/DC regulator in all sensors. However, all wiring running through the body of an automobile has to be 12V. This is necessary in the event the insulation of a wire is worn or a wire is pinched and the insulation is damaged. In this case, a short circuit between two or more wires might occur, and therefore all wires running in the same harness must be the same voltage level in order to prevent excessive current flow and excessive damage in such a failure case.

It is therefore not feasible in the conventional ultrasonic system 400 to utilize ultrasonic sensors which communicate with lower voltage logic level signals (e.g., 5 V) since the ECU is located inside the vehicle body and the sensors are located on the outside of the vehicle. The sensor DC power line and the sensor communication signal lines are routed within the main vehicle harness to connect all sensors to the ECU, so per the requirements above they operate at 12 V. Providing a separate harness for sensor communication wires is not a practical option as such an approach would be too expensive and add labor to the vehicle manufacturing for routing the additional harness from the control module inside the passenger compartment to the ultrasonic sensors mounted to the vehicle exterior.

In contrast, the ultrasonic traffic environment sensing system 300 of the invention enables the 12 V wiring of the vehicle and the 5 V wiring between ultrasonic sensors and a control module to be kept separate. More particularly, referring to FIG. 8, the system 300 provides a vehicle wire harnesses 302 operating at 12V that is separate from an internal bumper wire harness 304 operating at TTL or CMOS logic levels of 3.3 or 5V, as the case may be.

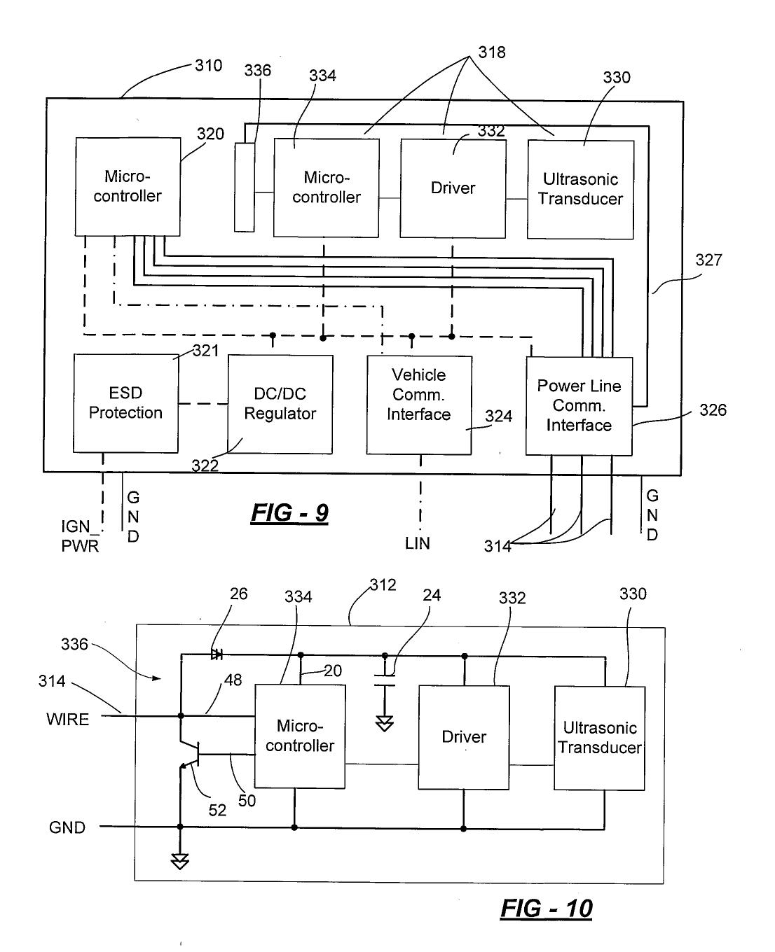

The different voltages in the wire harnesses 302 and 304 of the system 300 are made possible through the use of a main sensor (alternatively referred to as a “smart” sensor) 310, which communicates with a plurality of individual ultrasonic sensors 312. As seen in the block diagram of FIG. 9, the main sensor 310 includes its own ultrasonic sensor 318, which functions similar to one of the individual ultrasonic sensors 312. In addition, the main sensor 321 assumes most tasks previously provided by the ECU. The main sensor 321 provides all interfaces to the vehicle and all connections to the other ultrasonic sensors 312. The main sensor 321 isolates the 12 V arrangement of the vehicle from the 5 or 3.3 V logic level signals utilized by the other ultrasonic sensors 312.

As will be seen from FIG. 8, the main sensor 310 requires three connections to the vehicle in harness 302: 12 V DC power (IGN_PWR), chassis ground (GND), and vehicle communication line such as LIN (or a CAN) signal, as known to those skilled in the art. The logic level internal bumper harness 304 utilizes four connections since this harness is limited to connections with the other ultrasonic sensors 312 and is located behind the bumper fascia. Since there are no other wire harnesses in this area of the vehicle, any conflict between 5 V and 12 V signals is prevented by principle. A total of seven connections are thus required in system 300 (versus nine connections to the ECU of the conventional system) for a system with four ultrasonic sensors.

Each ultrasonic sensor 312 requires only two interface signals: a power communications line 314, which is a 5 V (or 3.3 V) power line communication wire, and sensor ground 316. The ultrasonic sensors 312 are shown with three-pin interfaces where the sensor ground 316 is looped, but a two pin interface may alternatively be utilized if the sensor ground is provided via suitable splices, as known in the art per se, in harness 304.

In alternative embodiments the ultrasonic sensors 312 may be connected to the main sensor 310 in a daisy chain arrangement, which would reduce even further the number of wires present in the internal bumper harness 304. However, it is more preferred that the ultrasonic sensors 312 be connected in a star topology with the main sensor 310 so that parallel communications can occur between the main sensor 310 and each of the individual ultrasonic sensors 312.

Referring additionally to FIG. 9, the main sensor 310 includes a protection circuit 321 that protects the sensor 310 from electrostatic discharge, reverse voltage and/or other causes that could damage the main sensor 310 or the other sensors 312. The input to the protection circuit 321 is the 12 V DC power IGN_PWR, and the output is fed to a DC/DC voltage regulator 322. The voltage regulator 322 converts the 12 V systems DC Power into a lower logical level voltage used by other functional blocks. The regulator 322 powers not only the internal functional blocks of the main sensor 312 as indicated, but also each individual ultrasonic sensor 312 through its respective power communications line 314 connection.

A main microcontroller 320 connects all the functional blocks. The microcontroller 320 controls the internal ultrasonic transducer 318 and the other external ultrasonic sensors 312 by means of a main-side power line communication interface 326. The interface 326 includes, in this embodiment, four instantiations of the circuit arrangement shown in FIG. 1 between the ECU 12 and the power communications line 22 such that the main microcontroller can communicate in parallel with four ultrasonic sensors. (Thus, the interface 326 includes four low impedance lines 32, each having impedance switch 36 controlled by the main microcontroller 320. The high impedance line 28 may be common, or a separate high impedance line may be associated with each ultrasonic sensor.) Three power line communications wires 314, which are incorporated in the bumper internal harness 304, are connected to the main-side power line communication interface 326 (each to one of the low impedance lines 32), and one output 327 of the interface 326 is routed internally in the main sensor 310 for powering and communicating with the internal ultrasonic transducer 318.

In alternative embodiments where the external ultrasonic sensors 312 are connected in daisy chain fashion the bumper internal harness 304 includes a single power line communications wire 314 that is connected to the main-side power line communication interface 326, which incorporates a single low impedance line 32 and impedance switch 34. In this arrangement, the preferred master/slave communications protocol above requires an addressing scheme to identify each external ultrasonic sensor 312 for communication.

The main microcontroller 320 processes all raw data provided by the ultrasonic sensors 312 and 318, and provides the processed data to the vehicle by means of a vehicle communication interface 324. The vehicle communication interface 324 is used to receive data from the vehicle such as activation status or other required parameters necessary for the operation of the system 300. The vehicle communication interface 324 is also used to provide data relating to the vehicle environment such as distance to the closest obstacle, and information regarding parking maneuvers, etc (System Outputs). The vehicle communication interface could be a LIN, CAN or any other vehicle communication interface used in the automotive industry, and in the preferred embodiment is a slave type of interface that, as shown in FIG. 8, communicates with a main communication interface that could be located, for instance, in the vehicle radio.

The internal ultrasonic sensor 318 and external ultrasonic sensors 312 preferably have the same functional blocks, including, as shown in FIG. 10, an ultrasonic transducer 330, driver hardware 332 for the ultrasonic transducer, and a microcontroller 334 that connects all the functional blocks. In addition, each ultrasonic sensor 312, 318 includes a sensor or slave power line communication interface 336 which, as seen in FIG. 10, is basically a reproduction of the circuit arrangement shown in FIG. 1 between power communications line 22 and the sensor 16. The microcontroller 334 monitors the power line communication wire 314 for commands issued by the main sensor 310 and controls the connected ultrasonic transducer 330.

It will be appreciated by those skilled in the art that the ultrasonic transducer 330, driver hardware 332 and microcontroller 334 may all be implemented as an application specific integrated circuit.

While the above describes a particular embodiment(s) of the invention, it will be appreciated that modifications and variations may be made to the detailed embodiment(s) described herein without departing from the spirit of the invention.

1. An ultrasonic object detection sensor system for automotive applications, comprising:
a main sensor including, in one enclosure, a master microcontroller functionally connected to a DC/DC voltage regulator, a vehicular communication interface, an internal ultrasonic sensor disposed within the enclosure, and an external sensor interface, wherein the DC/DC regulator has an input receiving a power signal from a vehicular wire harness at a first voltage level and has an output providing a power signal at a different, second voltage level, the DC/DC regulator output being connected to at least the external sensor interface;
a plurality of ultrasonic sensors each disposed external of the enclosure; and
a wire harness interconnecting the external ultrasonic sensors with the main sensor via its external sensor interface, the wire harness operating at the second voltage level and carrying at least one instance of the output power signal;
wherein the master microcontroller controls the internal and external ultrasonic sensors to send and receive ultrasonic bursts in order to detect a potential object within the field of view of each ultrasonic sensor, the master microcontroller consolidating data from the internal and external ultrasonic sensors and communicating the existence of an object to another device within the vehicle via the vehicular communication interface.

2. The system according to claim 1, wherein the wire harness includes at least one power communication wire for connecting the plurality of external ultrasonic sensors, each power communication wire being connected to the external sensor interface and carrying both power and digital communication signals at the second voltage level between the external ultrasonic sensor and the external sensor interface.

3. The system according to claim 2, wherein digital values are delineated by selective arrangement of the on and off flow of power over each power communication wire.

4. The system according to claim 3, wherein each external ultrasonic sensor includes a diode and a capacitor operably connected between the at least one power communications wire and a power supply input for the external sensor in order to continuously supply power to the external sensor when no power flows over the at least one power communications wire.

5. The system according to claim 4, wherein the external sensor interface includes:
a low impedance line connected between the DC/DC voltage regulator output and the at least one power communications wire;
a high impedance line connected between the DC/DC voltage regulator output and the at least one power communications wire, the high impedance line having a greater resistance than the low impedance line; and
an impedance switch in the low impedance line, the impedance switch being controlled by the master microcontroller to control the flow of power through the impedance line.

6. The system according to claim 5, wherein the external ultrasonic sensors are connected together in daisy chain fashion to the external sensor interface by a single power communications wire; there being a single low impedance line.

7. The system according to claim 6, including a communications protocol for uniquely addressing each ultrasonic sensor.

8. The system according to claim 5, wherein the plurality of external ultrasonic sensors are connected in parallel to the external sensor interface by a plurality of power communications wires, one for each external ultrasonic sensor; there being a plurality of low impedance lines, one for each external ultrasonic sensor.

9. The system according to claim 5, wherein the at least one power communications wire is connected to at least one input of the external ultrasonic sensor and the at least one power communications wire is also connected to a ground signal via a first switch controlled by the master microcontroller, thereby enabling the master microcontroller to communicate digital data to the ultrasonic sensor.

10. The system according to claim 9, wherein the at least one power communications wire is connected to an input of the master microcontroller and the at least one power communications wire is also connected to the ground signal via a second switch controlled by the external ultrasonic sensor, thereby enabling the external ultrasonic sensor to communicate digital data to the master microcontroller.

11. The system according to claim 9, wherein the master microcontroller controls the impedance switch to disconnect the DC/DC regulator output from the at least one low impedance line when a communications signal or a portion thereof is transmitted over the at least one power communications line to the at least one ultrasonic sensor.

12. The system according to claim 10, wherein master microcontroller communicates with the external ultrasonic sensors with a master/slave protocol and the master microcontroller controls the impedance switch to disconnect the DC/DC regulator output from the at least one low impedance line when a communications signal or a portion thereof is transmitted over the at least one power communications line to the master microcontroller.

13. The system according to claim 3, wherein a digital bit has a logic value of 0 or 1, wherein when said communication signal value is 1, a pulse at the second voltage level is transmitted across the at least one power communications wire for a first predetermined time period and when the communications signal value is 0, a pulse is transmitted through the at least one power communications wire at the second level for a second predetermined time period.

14. The circuit arrangement of claim 13, wherein said bit is transmitted within a predetermined time window greater than the first or second predetermined pulse periods.
